(19) United States
(12) Patent Application Publication
(10) Pub. No.: US 2026/0274083 A1
(43) Pub. Date: Sep. 17, 2026

(54) OUTPUT PHASE CURRENT REDUCTION SYSTEM FOR ELECTRIC VEHICLE

(71) Applicant: Honda Motor Co., Ltd., Tokyo (JP)

(72) Inventors: Dirk G. WESTENDORF, Marysville, OH (US); Diego R. Atanacio Pérez, Columbus, OH (US); David T. CHRISTIAN, JR., Troy, OH (US)

(21) Appl. No.: 19/078,259

(22) Filed: Mar. 12, 2025

(51) Int. Cl. B60L 15/20; B60L 50/60

(52) U.S. Cl. CPC B60L 15/2045; B60L 50/60; B60L 2240/421; B60L 2250/16; B60L 2250/28

(57) ABSTRACT

An output phase current reduction system for an electric vehicle can include a controller. The electric vehicle including a battery pack, a plurality of wheels, and an electric motor that is configured to drive at least one of the wheels with electric power from the battery pack. The controller can be configured to: be in electrical communication with the electric motor and the battery pack during operation of the vehicle in a first driving direction; and operate the electric motor in a phase current reduction mode by gradually reducing a phase current output to the electric motor from a present value to zero such that an acceleration of the electric vehicle in a direction opposed to the first driving direction is less than a predetermined threshold.

### BACKGROUND

The disclosed subject matter relates to operating an electric propulsion motor of a vehicle. More particularly, the disclosed subject matter relates to methods and apparatus that reduce a phase current output that drives the electric propulsion motor.

An electric vehicle can include at least one electric propulsion motor that drives at least one of the wheels of the electric vehicle. The speed at which the wheel is driven can vary by varying a phase current that is output to the electric propulsion motor. The operator of the vehicle can cause the phase current to vary by moving an accelerator pedal to decelerate the vehicle, accelerate the vehicle, or maintain a travel speed of the vehicle.

### SUMMARY

Some embodiments are directed to an output phase current reduction system for an electric vehicle. The electric vehicle can include a battery pack, a plurality of wheels, and an electric motor that is configured to drive at least one of the wheels with electric power from the battery pack. The output phase current reduction system can include a controller that is configured to: be in electrical communication with the electric motor and the battery pack during operation of the vehicle in a first driving direction; and operate the electric motor in a phase current reduction mode by gradually reducing a phase current output to the electric motor from a present value to zero such that an acceleration of the electric vehicle in a direction opposed to the first driving direction is less than a predetermined threshold.

Some embodiments are directed to an output phase current reduction system for an electric vehicle. The electric vehicle can include an accelerator pedal, a battery pack, a plurality of wheels, and an electric motor that is configured to drive at least one of the wheels with electric power from the battery pack. The output phase current reduction system can include a position sensor and a controller. The position sensor can be configured to output data that is indicative of a position of the accelerator pedal within a range from a released position to a maximum position. The controller can be configured to: be in electrical communication with the position sensor, the electric motor, and the battery pack; operate the electric motor in a normal mode in which the controller causes a normal value of a phase current to be output to the electric motor, the normal value is proportional to the position of the accelerator pedal; and terminate the normal mode and operate the electric motor in a phase current reduction mode if: a rotational speed of the electric motor is less than a speed threshold; and the phase current is greater than a current threshold. The controller can gradually decrease the phase current output to the electric motor from the normal value to a value less than the normal value when the controller operates the electric motor in the phase current reduction mode.

Some embodiments are directed to an output phase current reduction system for an electric vehicle. The electric vehicle can include an accelerator pedal, a battery pack, a plurality of wheels, and an electric motor that is configured to drive at least one of the wheels with electric power from the battery pack. The output phase current reduction system can include a position sensor and a controller. The position sensor can be configured to output data that is indicative of a position of the accelerator pedal within a range from a released position to a maximum position. The controller can be configured to: be in electrical communication with the position sensor, the electric motor, and the battery pack; if one of a forward drive direction and a reverse drive direction is selected, operate the electric motor in one of: a normal mode in which the controller causes a normal value of a phase current to be output to the electric motor, the normal value is proportional to the position of the accelerator pedal; and a phase current reduction mode in which the controller gradually decreases the phase current output to the electric motor from the normal value to a value less than the normal value; and terminate the normal mode and operate the electric motor in the phase current reduction mode if: a rotational speed of the electric motor is less than a speed threshold; and the phase current is greater than a current threshold.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is schematic view of an electric vehicle made in accordance with principles of the disclosed subject matter and traversing an inclined path.

FIG. 2 is a schematic view of the electric vehicle of FIG. 1.

FIG. 3 is a flowchart of a motor drive control algorithm that can be executed by a controller of the electric vehicle of FIG. 1.

FIG. 4 is a flowchart of a phase current reduction algorithm that can be executed by the controller of the electric vehicle of FIG. 1.

FIG. 5 is a timing diagram of signals during the operation of the phase current reduction mode of FIG. 3.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

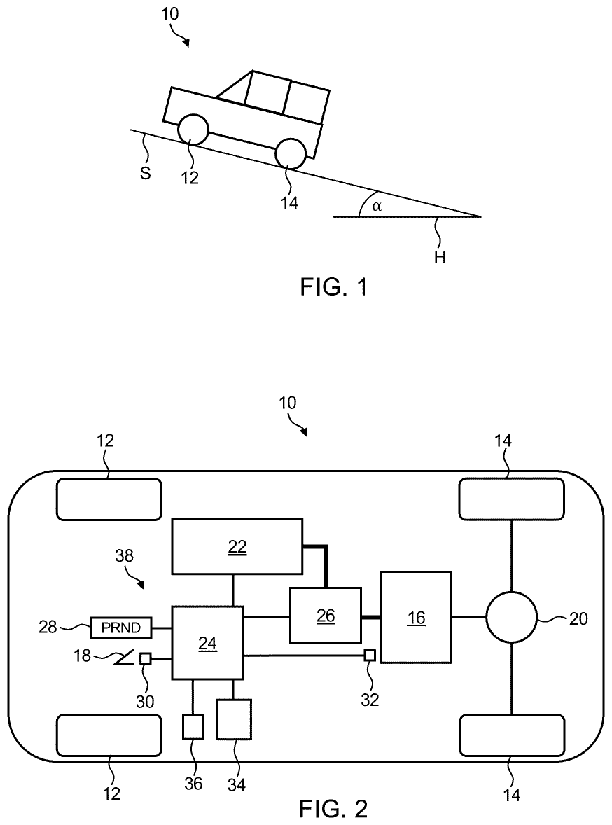

FIG. 1 illustrates an embodiment of an electric vehicle 10 (hereinafter vehicle 10) made in accordance with principles of the disclosed subject matter. The vehicle 10 shown in FIG. 1 can be specialized for use on an unimproved path or on an unmarked path, and can be referred to as a single-seat all-terrain vehicle (single-seat ATV), a multipurpose utility vehicle (MUV) or as a side-by-side all-terrain vehicle (SxS, or SxS ATV). However, the vehicle 10 can be any vehicle that is configured for travel along any one or combination of improved, unimproved, and unmarked paths. For example, embodiments are intended to include or otherwise cover any type of automobile, including a passenger car, minivan, truck, tractor, lawnmower, other types of all-terrain vehicle (ATV), semi-tractor, off-highway vehicle, etc.

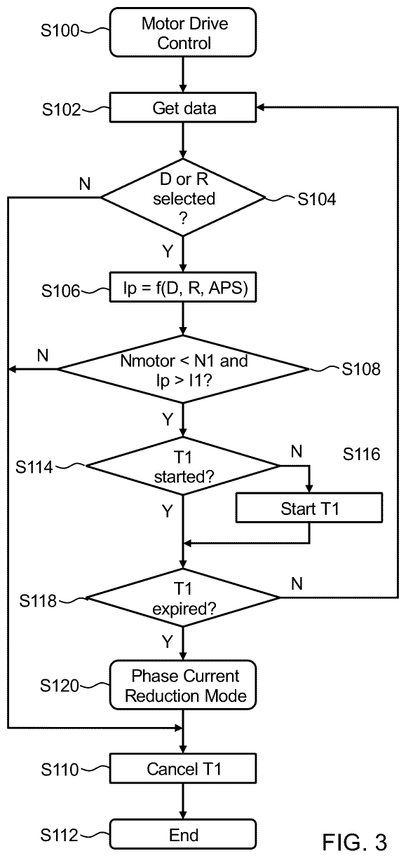

Referring to FIG. 2, the vehicle 10 can include a pair of front wheels 12, a pair of rear wheels 14, an electric motor 16, an accelerator pedal 18 and a differential 20. The electric motor 16 can drive both of the rear wheels 14 via the differential 20.

Returning to FIG. 1, the vehicle 10 can travel up an inclined surface S that is inclined at an angle α relative to a horizontal surface H. The vehicle 10 can travel up the inclined surface S if the electric motor 16 is driven in a forward direction or in a reverse direction, depending on the orientation of the vehicle 10. The vehicle 10 can travel down the inclined surface S if the electric motor 16 is driven in the forward direction or the reverse direction, depending on the orientation of the vehicle 10.

Under certain circumstances, progress of the vehicle 10 can be stopped or hindered even when a phase current is supplied to the electric motor 16, either in the forward direction or the reverse direction. For example, the operator can use the electric motor 16 to hold the vehicle 10 stationary on an inclined surface S. In another example, an object such as, but not limited to, a log, a tree branch, or a rock may abut one or both of the front wheels 12 (if the vehicle 10 is traveling in a forward direction) and be of sufficient size that the front wheel(s) 12 cannot roll over the object. Under these certain circumstances, the rotor of the electric motor 16 can be stationary or rotating at a low speed despite a relatively high value of the phase current being output to the electric motor 16. In this state, the rotor can be described as being locked or in a locked state. In the locked state, the phase current output to the electric motor 16 can be converted into heat that can impair and/or damage the electric motor 16. Thus, it can be a failsafe precaution to terminate the phase current output to the electric motor 16 if the rotor is in the locked state.

However, if the phase current is reduced or completely terminated when the vehicle 10 is on an inclined surface S as shown in FIG. 1, the vehicle 10 could roll backward down the inclined surface S. The drivetrain resistance of the vehicle 10 can be much lower than that of a comparably sized vehicle that is driven by an internal combustion engine. The decreased drivetrain resistance of the vehicle 10 can allow a larger downhill acceleration to act on the vehicle 10. Thus, it can be desirable to gradually reduce the phase current output to the electric motor 16 and notify the operator of the vehicle 10 that the phase current will be reduced. The notification to the operator can signal the operator to apply the mechanical braking system and modulating the phase current reduction can provide the operator with sufficient time to apply the mechanical braking system of the vehicle 10 so that the operator can calmly stop the downhill travel of the vehicle 10. The system can also be applied to a vehicle 10 that has simply run into an obstacle even if no downhill acceleration is imminent in order to avoid damage to the motor 16 and allow the operator to calmly take various actions that might be necessary for the vehicle 10.

Returning to FIG. 2, the vehicle 10 can include a battery pack 22, an inverter 26 and a phase current reduction system 38. The phase current reduction system 38 can be configured to detect a locked state of the rotor and alert the operator of the vehicle that the phase current output to the electric motor 16 will be reduced. Thus, if the vehicle 10 is on an inclined surface, the operator can be prepared to calmly apply the mechanical braking system of the vehicle 10. The phase current reduction system 38 can include a controller 24, a drive selector 28, an accelerator pedal sensor (APS) 30, a motor speed sensor 32, a display 34 and an audio device 36.

The battery pack 22 can include one or more battery cells. If the battery pack incudes one or more battery cells, the battery cells can be connected in series or in parallel individually or arranged into groups of battery cells where the groups of battery cells are connected in series or parallel in order to achieve the desired current and voltage.

The controller 24 can be in electric communication with the electric motor 16 via the inverter 26 and the motor speed sensor 32. The controller 24 can be in electrical communication with the battery pack 22, the inverter 26, each of the sensors 28, 30, 32, the display 34 and the audio device 36.

The controller 24 can be a processor-based controller configured with hardware, with or without software, to perform the assigned task(s). The controller 24 also can be referred to as an electronic control unit (ECU), a central processing unit (CPU), a microcomputer or a microprocessor. The controller 24 can be configured to operate the electric motor 16 in a forward rotation or a reverse rotation based on a signal from the drive selector 28 and at a requested speed based on a signal from the APS 30. The controller 24 can be configured to output a drive signal to the inverter 26 that causes the inverter 26 to output a phase current that corresponds to the position of the accelerator pedal 18 that has been selected by the operator of the vehicle 10.

The inverter 26 can be in electrical communication with the battery pack 22, the controller 24 and the electric motor 16. The inverter 26 can be any appropriate device that can convert the DC power output by battery pack 22 into three-phase AC power and output a phase current to the electric motor 16. The inverter 26 can be configured to vary the magnitude and polarity of the phase current based on the drive signal received from the controller 24. The inverter 26 can also be referred to as a motor driver.

The vehicle 10 can include a plurality of operational states that include park P, a reverse drive R, neutral N, and a forward drive D. The drive selector 28 can be configured to output a signal that is indicative of the operator's requested one of the operational states P, R, N, D. The drive selector 28 can be a mechanical structure or an icon on a touch screen. The mechanical structure can include any appropriate structure such as, but not limited to, a lever, a rotary dial, a plurality of push buttons, a sliding switch.

The operator can displace the accelerator pedal 18 from a released position to a maximum position. The released position can correspond to the operator's request for the vehicle 10 to stop moving or to remain stationary (i.e. a vehicle speed of zero). The maximum position can correspond to the operator's request for maximum acceleration and/or a maximum travel speed of the vehicle 10. The accelerator pedal 18 can move continuously from the released position to the maximum position and be maintained at any position between (and including) the released position and the maximum position.

The APS 30 can be adjacent to the accelerator pedal 18, configured to detect the position of the accelerator pedal 18, and output a signal that is indicative of the position of the accelerator pedal 18. The APS 30 can be configured to output a signal that is a percentage, where 0% corresponds to the released position of the accelerator pedal 18 and 100% corresponds to the maximum position of the accelerator pedal 18.

The motor speed sensor 32 can be any appropriate sensor that can detect the rotational speed of the rotor or the drive shaft of the electric motor 16 and output a signal that is indicative of the rotational speed.

The display 34 can be a simple structure such as, but not limited to, a flashing LED, and an illuminated lamp with or without a printed message and/or icon. Alternate embodiments of the display 34 can be an LCD screen that presents a message and/or image that provides detailed information via text, images, video or other means embedded in the image. Exemplary embodiments that include the LCD can include the drive selector 28 as an icon or image on the LCD.

The audio device 36 can be a speaker and can emit any appropriate audible message such as, but not limited to, a buzzer, a repeating beep, or a recorded or generated verbal message.

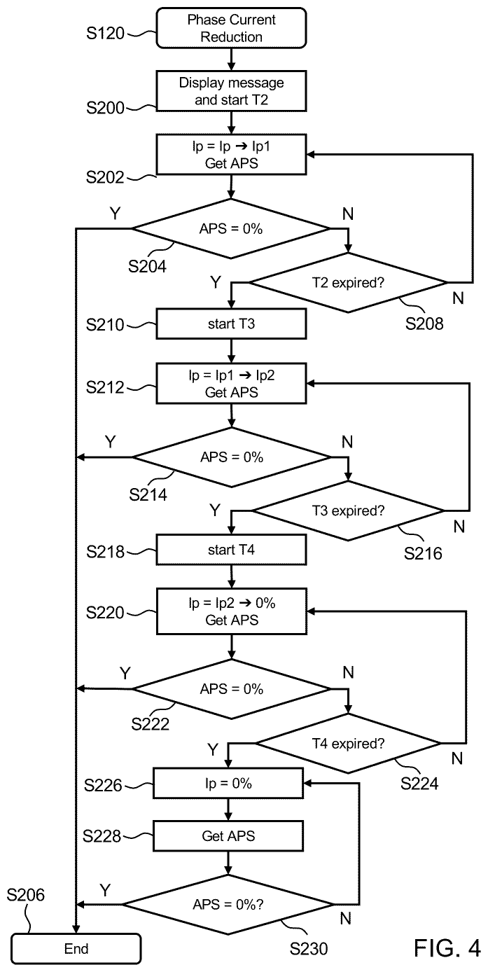

FIG. 3 shows a flowchart that depicts a motor drive control algorithm for the vehicle 10 that the controller 24 can execute to cause the electric motor 16 to propel the vehicle 10 in accordance with the operator's input(s) or autonomously operate the electric motor 16 in phase current reduction mode. The drive control algorithm can include a phase current reduction subroutine. The controller 24 can be configured to initiate the drive control algorithm at step S100. From step S100, the controller 24 can be configured to proceed to step S102.

At step S102, the controller 24 can be configured to receive or retrieve the signals from each of the drive selector 28, the APS 30 and the motor speed sensor 32. From step S102, the controller 24 can be configured to proceed to step S104.

At step S104, the controller 24 can be configured to use the signal from the drive selector 28 to determine whether or not the operator has requested the vehicle 10 be driven in a forward direction, a reverse direction, or to be not driven (i.e., placed in park P or neutral N). If the controller 24 determines that the operator has requested neither forward drive D nor reverse drive R, the controller can proceed to S110. If the controller 24 determines that the operator has requested forward drive D or reverse drive R, the controller can proceed to S106.

At step S106, the controller 24 can be configured to determine a requested phase current that is based on the signals from the drive selector 28 and the APS 30. The controller 24 can be configured to determine the polarity of the phase current based on the operator's selection of forward drive D or reverse drive R and determine the magnitude of a requested phase current based on the signal from the APS 30. The magnitude of the requested phase current can be a value expressed in amperes, or a percentage of the maximum rated phase current for the electric motor 16.

The controller 24 can be configured to output the requested phase current and polarity as a signal to the inverter 26. The inverter 26 can be configured to transform the DC power it receives from the battery pack 22 into an AC power output that includes a phase current output Ip that corresponds to the requested phase current and polarity. From step S106, the controller 24 can be configured to proceed to step S108. The magnitude of the phase current output Ip can be expressed in amperes, or as a percentage of the maximum rated phase current for the electric motor 16.

Starting at step 108, the controller 24 can be configured to monitor the motor speed Nmotor (expressed in revolutions per minute or RPM) of the electric motor 16 and the phase current output Ip to determine whether or not the rotor of electric motor 16 is in, or about to enter, the locked state. If the motor speed Nmotor is disproportionally small as compared to the phase current output Ip, the rotor can be in, or about to enter, the locked state. The controller 24 can be configured to determine whether or not the phase current output Ip properly correlates to the motor speed Nmotor. If there is no proper correlation, then it is possible that the rotor is in, or about to enter, the locked state. If the motor speed Nmotor properly correlates to the phase current output Ip, then it is unlikely that the rotor is in, or about to enter, the locked state. The controller 24 can be configured to receive or retrieve a signal from either the inverter 26 or the electric motor 16 that is indicative of the phase current output Ip.

Specifically, the controller 24 can be configured to compare a motor speed Nmotor to a speed threshold N1 and compare the phase current output Ip to a current threshold I1. The speed threshold N1 can be a relatively small value and the current threshold I1 can be a value that is larger than a phase current that would correlate to the speed threshold N1. For example, if the speed threshold N1 has a value of 50 RPM, the current threshold I1 can have a value that is 30% of the maximum rated phase current for the electric motor 16. However, a phase current output Ip that has a value of 30% can be intended to produce a motor speed Nmotor that is greater than 50 RPM. This exemplary combination of thresholds N1, I1 can be indicative of the locked state of the rotor. The thresholds I1, N1 can be set at any appropriate value that provides the desired performance for the phase current reduction mode of the electric motor 16. If the controller 24 determines that either condition of step S108 is false, the controller 24 can be configured to proceed to step S110.

If either of the conditions of step S108 are false, then the rotor can be operating normally and the locked state is not present. At step S110, the controller 24 can be configured to cancel a first timer T1 that will be described below. The first timer T1 is irrelevant for the proper operation the controller 24 and the electric motor 16 during steps S110 and S112. Thus, cancelling the first timer T1 at step S110 can be appropriate. From step S110, the controller 24 can be configured to proceed to step S112 and exit the motor drive control algorithm.

The sequence of steps S100, S102, S104, S106, S108, S110 and S112 can be referred to as a normal driving mode for the electric motor 16. If the controller 24 operates the electric motor 16 in the normal driving mode, the controller 24 can be configured to output a signal to the inverter 26 that causes the inverter 26 to drive the electric motor with the phase current output Ip.

Returning Step S108, if the controller 24 determines that both conditions of step S108 are true, then the controller 24 can be configured to proceed to step S114.

It is possible for the rotor to be in a locked state for a short time interval, and then without any intervention from the controller 24, transition out of the locked state. Operating the electric motor 16 in the phase current reduction mode can interrupt the travel of the vehicle 10. The operator and/or passenger(s) of the vehicle 10 can adversely perceive the interruption of the travel of the vehicle 10 if the controller 24 prematurely causes the electric motor 16 to operate in the phase current reduction mode. Further, if the transient locked state ends relatively quickly, then it is possible that any adverse effect(s) to the electric motor 16 can be avoided and it would not be beneficial to interrupt the traveling of the vehicle 10 by operating the electric motor 16 in the phase current reduction mode with every instantaneous occurrence of the locked state. Thus, it can be advantageous to determine if the rotor is in a transient locked state or a persistent locked state.

At step S114, the controller 24 can be configured to determine if the rotor is in a transient locked state or a persistent locked state. The controller 24 can be configured to initiate a monitoring operation in which the controller 24 monitors the motor speed Nmotor and the phase current output Ip during the time period of a 1st timer T1. Monitoring the motor speed Nmotor and the phase current output Ip during the time period of the 1st timer T1 can more accurately assess whether the rotor is in a persistent locked state or a transient locked state. Thus, the monitoring can be used to refine the decision on whether to enter the phase current reduction mode. The monitoring can be continuous or at predetermined intervals during the time period of the 1st timer T1.

At step S114, the controller 24 can be configured to determine whether the first timer T1 has started. The first timer T1 will not have started if the controller 24 is currently operating the electric motor 16 in the normal driving mode and the first timer T1 would have been started if the controller 24 is currently operating the electric motor 16 in the phase current reduction mode. If the controller 24 determines that the first timer T1 has not started, then the controller 24 can proceed to step S116.

At step S116, the controller 24 can be configured to start the first timer T1. The first timer T1 can be a countdown timer or an increasing timer. From step S116, the controller 24 can be configured to proceed to step S118.

Returning to step S114, if the controller 24 determines that the first timer T1 has started, then the controller 24 can proceed to step S118.

At step S118, the controller 24 can be configured to determine whether the first timer T1 has expired. That is, the controller 24 can be configured to determine whether the value of the first timer has reached 0 if the first timer T1 is a countdown timer, or whether the first timer T1 has a value that corresponds to a predetermined elapsed time if the first timer T1 is an increasing timer. From S118, the controller can be configured to proceed to step S120.

At step S120, the controller 24 can be configured to initiate the phase current reduction algorithm. The phase current reduction algorithm can be referred to as a subroutine of the motor drive control algorithm.

Abruptly reducing the phase current output Ip from a present value to zero can adversely impact the driver, any passenger(s) and/or the vehicle 10. The phase current reduction algorithm can permit the controller 24 to cause the inverter 26 to operate the electric motor 16 in a phase current reduction mode by gradually reducing the phase current output Ip from a present value to zero over a predetermined period of time. The predetermined period of time can be any appropriate value that can provide the operator of the vehicle 10 time to calmly apply the mechanical braking system of the vehicle 10 without adversely impacting the electric motor 16 due to the locked state of the rotor.

The phase current reduction algorithm can include three reduction intervals. During the first reduction interval, the controller 24 can cause the inverter 26 to reduce the phase current output Ip from the present value to a predetermined first value Ip1 that is greater than zero. During the second reduction interval, the controller 24 can cause the inverter 26 to reduce the phase current output Ip from the predetermined first value Ip1 to a predetermined second value Ip2 that is greater than zero and less than the first value Ip1. During the third reduction interval, the controller 24 can cause the inverter 26 to reduce the phase current output Ip from the second value Ip2 to zero. Thus, the phase current reduction mode algorithm can instruct the controller 24 to gradually reduce the phase current output Ip from the present value of the phase current output Ip at the start of the phase current reduction mode to zero.

If the vehicle 10 is travelling uphill when the controller 24 initiates the phase current reduction algorithm, the acceleration in the reverse direction can be reduced, as compared to an abrupt reduction to zero of the phase current output Ip. Thus, the phase current reduction algorithm can mitigate or prevent the adverse effect(s) caused by a locked state of the rotor and assist the operator of the vehicle 10 to achieve calm control of the vehicle 10.

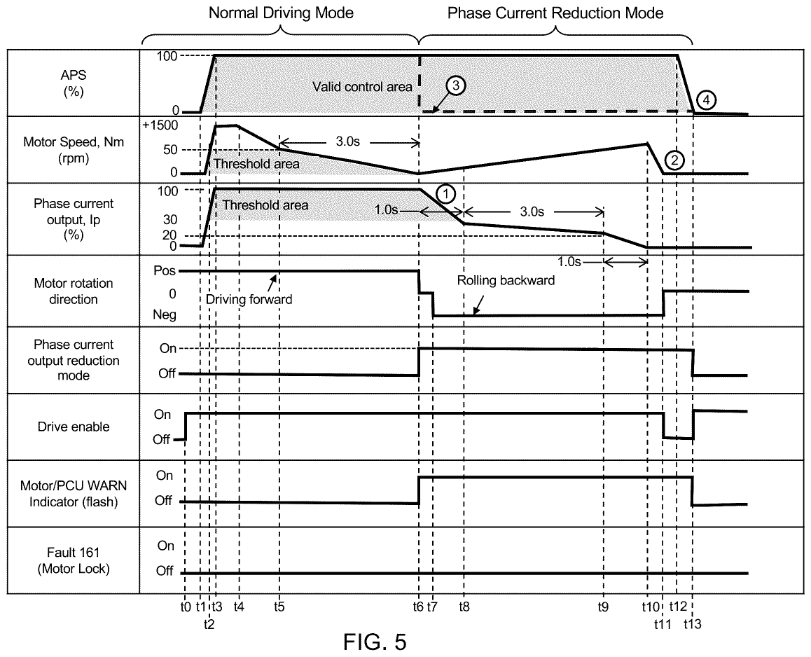

FIG. 4 shows a flowchart that depicts the phase current reduction algorithm that the controller 24 can execute to operate the electric motor 16 in a phase current reduction mode. The controller 24 can be configured to proceed from step S120 to step S200.

At step S200, the controller 24 can be configured to cause the display 34 and the audio device 36 to emit the notification to the operator of the vehicle 10 and start a predetermined second timer T2. The notification can indicate that the phase current reduction mode has been initiated and instruct the operator to apply the mechanical braking system. During the duration of the second timer T2, the controller 24 can be configured to reduce the present value of the phase current output Ip to the first value Ip1 at a first reduction rate r1. From step S200, the controller 24 can be configured to proceed to step S202.

At step S202, the controller 24 can also be configured to determine a first reduction rate r1 and output a signal to the inverter 26 that causes the inverter 26 to reduce the phase current output Ip from the present value to the first value Ip1 at the first reduction rate r1. The first reduction rate r1 can be a linear function and the controller 24 can be configured to calculate the first reduction rate r1 by dividing the difference between the present value of the phase current output Ip and the first value Ip1 by the value of the duration value of second timer T2 (i.e., r1=(Ip−Ip1)/T2).

It can be advantageous to terminate the phase current reduction algorithm if the operator releases the accelerator pedal 18 and allows the accelerator pedal 18 to return to the released position (i.e., the signal from APS 30 is 0%). The phase current output Ip can have a value of 0% if the acceleration pedal 18 is in the released position. As a result, the rotor is no longer in the locked state and the controller 24 can terminate the phase current reduction algorithm. Thus, the controller 24 can be configured to periodically check the signal from the APS 30. At step S202, the controller 24 can be configured to receive or retrieve the most recent or real-time signal from the APS 30.

From step S202, the controller 24 can be configured to proceed to step S204.

At step S204, the controller 24 can be configured to determine whether the operator has released the accelerator pedal 18. If the controller 24 determines that the pedal position is equal to 0%, the controller 24 can proceed to step S206 and end the phase current reduction algorithm. If the controller 24 determines that the pedal position is not equal to 0%, the controller 24 can proceed to step S208.

At step S208, the controller 24 can be configured to determine whether the second timer T2 has expired. If controller 24 determines that the second timer T2 has not expired, the controller 24 can be configured to return to step S202 and continue signaling the inverter 26 to reduce the phase current output at the first rate r1. If the controller 24 determines that the second timer T2 has expired, then the value of the phase current output Ip corresponds to the first value Ip1 and the controller 24 can be configured to proceed from step S208 to step S210.

At step S210, the controller 24 can be configured to start a predetermined third timer T3. During the time period of the third timer T3, the controller 24 can be configured to reduce the phase current output Ip from the first value Ip1 to the second value Ip2 at a second reduction rate r2. From step S210, the controller 24 can be configured to proceed to step S212.

At step S212, the controller 24 can be configured to determine the second reduction rate r2 and output a signal to the inverter 26 that causes the inverter 26 to reduce the phase current output Ip from the first value Ip1 to the second value Ip2 at the second reduction rate r2. The second reduction rate r2 can be a linear function and the controller 24 can be configured to calculate the second reduction rate r2 by dividing the difference between the first value Ip1 and the second value Ip2 by the duration value of the third timer T3 (i.e., r2=(Ip1−Ip2)/T3).

The first value Ip1 and the second value Ip2 can be predetermined values. Thus, in alternate embodiments, the second reduction rate r2 can be a predetermined value stored in a memory storage device. At step S212, the controller 24 can be configured to retrieve the second reduction rate r2 from the memory storage device instead of calculating the second reduction rate r2.

At step S212, the controller 24 can be configured to receive or retrieve the most recent or real-time signal from the APS 30. From step S212, the controller 24 can be configured to proceed to step S214.

At step S214, the controller 24 can be configured to again determine whether the operator has released the accelerator pedal 18. If the controller 24 determines that the pedal position is equal to 0%, then controller 24 can proceed to step S206 and end the phase current reduction algorithm. If the controller 24 determines that the pedal position is not equal to 0%, the controller 24 can proceed to step S216.

At step S216, the controller 24 can be configured to determine whether the third timer T3 has ended. If controller 24 determines that the third timer T3 has not ended, the controller 24 can be configured to return to step S212 and continue signaling the inverter 26 to reduce the phase current output at the second rate r2. If the controller 24 determines that the third timer T3 has ended, then the value of the phase current output Ip corresponds to the second value Ip2 and the controller 24 can be configured to proceed from step S216 to step S218.

At step S218, the controller 24 can be configured to start a predetermined fourth timer T4. During the duration of the fourth timer T4, the controller 24 can be configured to reduce the present value of the phase current output Ip from the second value Ip2 to zero at a third reduction rate r3. From step S218, the controller 24 can be configured to proceed to step S220.

At step S220, the controller 24 can be configured to determine the third reduction rate r3 and output a signal to the inverter 26 that causes the inverter 26 to reduce the phase current output Ip from the second value Ip2 to zero at the third reduction rate r3. The second reduction rate r3 can be a linear function and the controller 24 can be configured to calculate the second reduction rate r3 by dividing the second value Ip2 by the duration value of the fourth timer T4 (i.e., r3=Ip2/T4).

Since the second value Ip2 can be a predetermined value, in alternate embodiments, the third reduction rate r3 can be a predetermined value stored in the memory storage device. At step S220, the controller 24 can be configured to retrieve the third reduction rate r3 from the memory storage device instead of calculating the third reduction rate r3.

At step S220, the controller 24 can be configured to receive or retrieve the most recent or real-time signal from the APS 30. From step S220, the controller 24 can be configured to proceed to step S222.

At step S222, the controller 24 can be configured to again determine whether the operator has released the accelerator pedal 18. If the controller 24 determines that the pedal position is equal to 0%, then controller 24 can proceed to step S206 and end the phase current reduction algorithm. If the controller 24 determines that the pedal position is not equal to 0%, the controller 24 can proceed to step S224.

At step S224, the controller 24 can be configured to determine whether the fourth timer T4 has ended. If controller 24 determines that the fourth timer T4 has not ended, the controller 24 can be configured to return to step S220 and continue signaling the inverter 26 to reduce the phase current output at the third rate r3. If the controller 24 determines that the fourth timer T4 has ended, then the value of the phase current output Ip corresponds to zero and the controller 24 can be configured to proceed from step S224 to step S226.

At step S226, the controller 24 can output a signal to the inverter 26 that Indicates a phase current output of 0%. That is, the controller 24 can signal the inverter 26 to cease driving the electric motor 16. From step S226, the controller 24 can return to step S228.

At step S228, controller 24 can be configured to receive or retrieve the most recent or real-time signal from the APS 30. From step S228, the controller 24 can be configured to proceed to step S230.

At step S230, the controller 24 can determine whether it is appropriate to resume a normal driving mode for the electric motor 16 or maintain the electric motor 16 in the phase reduction mode. At step S230, the controller 24 can be configured to determine if the value of pedal position obtained from signal from the APS 30 is equal to 0%.

If the pedal position value is equal to 0%, then it is likely that the operator of the vehicle 12 has allowed the accelerator pedal 18 to return to the released position. The phase current output Ip can have a value of 0% if the accelerator pedal 18 is in the released position. Thus, the rotor can be out of the locked state and the electric motor 16 can be operated in the normal driving mode.

If the pedal position value is not equal to 0%, then the operator of the vehicle 12 has not released the accelerator pedal 18 and the rotor could return to the locked state, if the controller 24 causes the electric motor 16 to operate in the normal driving mode. Thus, it would not be advantageous to terminate the phase current reduction mode if the accelerator pedal 18 is not in the released position.

At step S230, if the controller 24 determines that the pedal position value is equal to 0%, then the controller 24 can proceed to step S206 and exit the phase current reduction algorithm. If the controller determines that the pedal position value is unequal to zero, then the controller 24 can return to step S226 and continue signaling the inverter 26 to cease outputting the phase current output Ip.

The controller 24 can continue the sequence of steps S226, S228, S230 and back to step S226 until the operator allows the accelerator pedal 18 to return to the released position. Thus, the controller 24 can be configured to maintain the electric motor 16 in the phase reduction mode after the fourth timer T has expired.

The duration of each of the second timer T2, the third timer T3 and the fourth timer T4 can be predetermined values. Any of the second timer T2, the third timer T3 and the fourth timer T4 can be a countdown timer or an increasing timer. At steps S208, S216, S224, the controller 24 can be configured to determine whether the timers T2, T3, T4 have expired, respectively. That is, the controller 24 can be configured to determine whether the value of the timers T2, T3, T4 has reached 0 if the timers T2, T3, T4 are a countdown timer, or whether the timers T2, T3, T4 have reached a value that corresponds to a predetermined elapsed time if the timers T2, T3, T4 are an increasing timer.

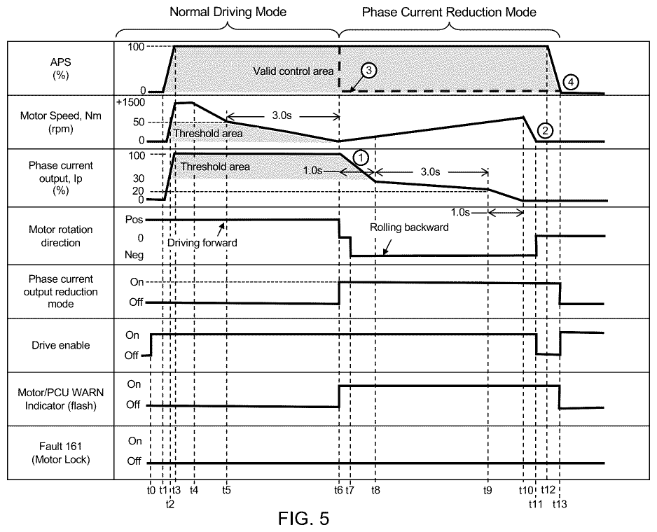

FIG. 5 is a timing diagram of an exemplary driving session of the vehicle 10 that illustrates an exemplary normal driving mode and an exemplary phase current reduction mode. For illustration only, each of the current threshold I1 and the first value Ip1 can have a value of 30% of the maximum rated current for the electric motor 16, the speed threshold Nmotor can have a value of 50 RPM, the second value Ip2 can have a value of 20% of the maximum rated current for the electric motor 16, the first timer T1 can have a duration of 3.0 s, the second timer T2 can have a duration of 1.0 s, the third timer T3 can have a duration of 3.0 s and the fourth timer T4 can have a duration of 1.0 s.

The phase current output Ip can have a positive value if the operator of the vehicle 10 selects the forward drive D and a negative value if the operator of the vehicle 10 selects the reverse drive R with the drive selector 28.

In the example depicted in FIG. 5, the vehicle 10 is initially stopped (i.e., the motor speed Nmotor has a value of zero) and the accelerator pedal 18 is in the released position (i.e., the position signal has a value of 0%).

At time t0, the operator of the vehicle 10 selects forward drive D with the drive selector 28. As a result, the drive enable signal can change from OFF to ON and the controller 24 can be configured to cause the inverter 26 to drive the electric motor 16 with a positive phase current output Ip.

Subsequently, at time t1 the operator depresses the accelerator pedal 18 (also referred to as tip-in or pedal tip-in or accelerator tip-in) and moves the accelerator pedal 18 from the released position (i.e. 0%) and toward the maximum position (i.e., 100%). The accelerator pedal 18 reaches the maximum position at time t3.

In the time interval of t1 to t2, the motor speed Nmotor can increase from 0 RPM to 50 RPM, and the phase current output Ip can increase from 0% to 30%. The second condition (i.e. Ip>30%) of step S108 is false and controller 24 can proceed to step S110 of FIG. 3. Thus, the controller 24 can initially cause the inverter 26 to operate the electric motor 16 in the normal driving mode and drive the electric motor 16 with the phase current output Ip.

At time t3, the motor speed Nmotor can reach the maximum speed of 1500 RPM and the phase current output Ip can have a value of 100% of the maximum rated phase current for the electric motor 16. The motor speed condition (i.e., Nmotor<50 RPM) of step S108 is false and controller 24 can proceed to step S110 of FIG. 3. Thus, the controller 24 can continue cause the inverter 26 to operate the electric motor 16 in the normal driving mode and drive the electric motor 16 with the phase current output Ip.

At time t4, the vehicle 10 can begin travelling uphill. As a result, the motor speed Nmotor can begin to decrease although the operator is maintaining the accelerator pedal 18 at the maximum position (i.e. 100%). From time t4 to time t5, the motor speed Nmotor decrease from +1500 RPM to 50RPM and the phase current output Ip remains at 100% because both conditions of step S108 remain false during this time interval.

If the controller 24 executes step S108 at time t5, then both conditions of step S108 will be true, the controller 24 can start the first timer T1 at step S116 and continue to monitor the motor speed Nmotor and phase current output Ip in accordance with step S108. The first timer T1 can have a duration of 3.0 s and controller 24 can be configured to obtain new values for the motor speed Nmotor and the phase current output Ip and compare the new values to the respective threshold N1, I1 for 3.0 s.

In the time interval from time t5 to time t6, the vehicle 10 can continue travelling in the forward direction and uphill. The motor speed Nmotor continues to decrease until it reaches a value of zero at time t6. Simultaneously, the operator is maintaining the accelerator pedal 18 in the maximum position (i.e. 100%) and the phase current output Ip remains at 100%. That is, both conditions at step S108 can remain true for the first time period T1. Thus, at time t6, the controller 24 can determine that the rotor of the electric motor 16 is in the locked state and can initiate the phase current reduction mode as indicated at “1” of FIG. 5 and shown at step S120 of FIGS. 3 and 4.

From time t6 to time t7, the rotor of the electric motor 16 can be stationary. That is, the rotor can continue to be in the locked state. At time t6, the controller 24 can execute step S200 of FIG. 4 and start the second timer T2. From time t6 to t8, the controller 24 can execute the sequence of steps from step S202 to step S204 to step S208 and back to step S202 until the phase current output Ip has a value of 30%, which corresponds to the first value Ip1.

At time t7, the vehicle 10 can begin rolling downhill in the reverse direction of the vehicle 10.

At time t8, the second timer T2 expires and the vehicle 10 can continue to accelerate downhill as indicated by the increasing motor speed Nmotor. However, the phase current output Ip (i.e., at least 30%) in the electric motor 16 can oppose at least a portion of the downhill acceleration, thus reducing the net acceleration acting on the vehicle 10. Although the change in the value of the phase current output Ip can be large during the period from time t6 to time t8, the period of the second timer T2 can be relatively short value of 1.0 s. Thus, the downhill acceleration of the vehicle 10 can be limited to a relatively small value, as reflected by the relatively low increase in the motor speed Nmotor at time t8.

At time t8, the controller 24 can execute the sequence of steps from step S212 to step S214 to step S216 and back to step S212 until the phase current output Ip has a value of 20%, which corresponds to the second value Ip2, at time t9.

At time t9, the second timer T2 expires and the vehicle 10 can continue to accelerate downhill as indicated by the increasing motor speed Nmotor. However, the phase current output Ip (i.e., at least 20%) in the electric motor 16 can continue to oppose at least a portion of the downhill acceleration, thus reducing the net acceleration acting on the vehicle 10.

At time t9, the controller 24 can execute the sequence of steps from step S220 to step S222 to step S224 and back to step S220 until the phase current output Ip has a value of 0% at time t10.

At time t10, the operator applies the mechanical braking system of the vehicle 10 and the vehicle speed slows to a stop, as indicated by the motor speed Nmotor decreasing to zero from time t10 to time t11, and the rotational direction of the electric motor 16 corresponding to zero in FIG. 5.

It can be advantageous to configure the phase reduction algorithm such that the controller 24 does not reset and return the electric motor 16 to the normal driving mode until the motor speed Nmotor reaches zero, as indicated at 2 in FIG. 5.

However, the operator maintains the accelerator pedal 18 in the maximum position (i.e., APS=100%) from time t3 until time t12 and the accelerator pedal 18 does not reach the release position (i.e., APS=0%) until time t13. Although the rotor is no longer in a locked state, the maximum position of the accelerator pedal at time t11 through time t12 will reintroduce the rotor to the locked state. Thus, the phase current reduction mode can remain in an ON state and the controller 24 can execute the sequence of steps from step S226 to step S228 to step S230 and back to step S226 to maintain the phase current output Ip at a value of 0% until the accelerator pedal 18 is in the released position. Execution of the sequence of steps from step S226 to step S228 to step S230 and back to step S226 can have the effect of disabling the drive of the electric motor 16 as indicated by the OFF value for the drive enabled state in FIG. 5.

At time t13, the accelerator pedal 18 has returned to the released position and the controller 24 can exit the phase current reduction algorithm as indicated by the OFF value for the state of the phase current reduction mode illustrated in FIG. 5 and the ON value for the drive enabled state illustrated in FIG. 5. If the operator depresses the accelerator pedal 18 after time t13, the controller 24 can operate the electric motor 16 in the normal drive mode.

As described above, the controller 24 can be configured to periodically check the pedal position value obtained from the APS 30 during the execution of phase current reduction algorithm. If the controller 24 determines that the operator has allowed the accelerator pedal 18 to return to the released position (i.e., APS=0%), then the controller 24 can exit the phase current reduction algorithm, as indicated by the thick, dashed line 3 of FIG. 5. FIG. 5 shows an exemplary alternate timeline at 3 where, instead of maintaining the accelerator pedal 18 in the maximum position, the operator releases the pedal at time t6. Instead of initiating the phase current reduction mode, the controller 24 is configured to continue operating the electric motor 16 in the normal drive mode. Similarly, if at any time after time t6 and prior to time t13 the operator releases the accelerator pedal 18 and the signal from the APS includes a value of 0%, then the controller 24 can determine that the condition at any appropriate one of steps S204, S206, S222 is true. As a result, the controller 24 can be configured to end operation of the electric motor 16 in the phase current reduction mode and resume operation of the electric motor 16 in the normal driving mode. Thus, the controller 24 can effectively and efficiently operate the electric motor 18 in the normal driving mode while guarding against any adverse condition(s) that may result from the rotor reaching the locked state.

In summary, the phase current reduction algorithm can permit the controller 24 to cause the electric motor 16 to operate in a phase current reduction mode after a predetermined time to address a persistent locked state of the rotor. When in the phase current reduction mode, the phase current output Ip can be gradually reduced from the present value to zero. This gradual reduction can oppose at least a portion of the downhill acceleration if the vehicle 10 is traveling uphill on an inclined surface S. Accordingly, the phase current reduction algorithm can mitigate or avoid any adverse effect(s) to the electric motor 16 if the rotor is held in a locked state for a predetermined time period and can reduce the downhill acceleration of the vehicle 10 as compared to abruptly terminating phase current output Ip to the motor electric 16.

Further, prior to reducing the phase current output Ip, the phase current reduction algorithm can instruct the operator to apply the mechanical braking system and that the phase current output to the electric motor 16 will cease. Thus, the operator can calmly bring the vehicle 10 to a stop if the vehicle 10 is traveling up an inclined surface.

It can be advantageous to continue operating the phase current reduction mode until the motor speed Nmotor is stopped, or nearly stopped. For example, the controller 24 can be configured to terminate the phase current reduction mode if the motor speed is 0 to 50 RPM.

It can be also advantageous to allow tip-out of the accelerator pedal (i.e., APS=0%) to enable the controller 24 to cancel the phase current reduction mode and resume the normal driving mode at any time during the execution of the phased current reduction mode. Further, it can be advantageous to rely on tip-out of the accelerator pedal 18 to cancel the phase current reduction mode even if the phase current Ip has a value of zero.

Although the description above is directed toward the vehicle 10 traveling in a forward direction D up the inclined surface S, the operation of the controller 24 in the phase current reduction algorithm can be equally applicable to vehicle 10 travelling in the reverse direction R up the inclined surface or against an obstacle. The audio device 36 can provide an audible notice to the operator of the impending activation of the phase current reduction mode if the display 34 is not in the line of sight of the operator.

While certain embodiments of the invention are described above, it should be understood that the invention can be embodied and configured in many different ways without departing from the spirit and scope of the invention.

The vehicle 10 described above includes a single electric motor 16 that only drives the rear wheels 14. However, in alternate embodiments, the electric motor 16 can drive only the front wheels 12. In other alternate embodiments, the electric motor 16 can drive all of the wheels 12, 14. Alternate embodiments can include a second electric motor that drives the front wheels 12, and the controller 24 can be configured to operate each electric motor in the phase current reduction mode.

The order of the steps of the motor drive control algorithm and the phase current reduction algorithm can be rearranged to achieve a desired performance of the vehicle 10. For example, step S106 can be swapped with step S108 in FIG. 3. In another alternate embodiment, any one or two of the steps S204, S214, S222 of FIG. 4 can be omitted. In FIG. 4, either or both of steps S212, S220 can be separated into two steps—a first step for reducing the phase current output Ip and a second step for receiving/retrieving the signal from the APS 30.

Instead of relying on the second, third and fourth timers T2, T3, T4, alternate embodiments of the controller 24 can be configured to reduce the present phase current output Ip by the first reduction rate r1 and compare the present phase current output Ip to the first value Ip1 until the present phase current output Ip is equal to the first value Ip1. Then, the controller 24 can be configured to reduce the present phase current output Ip by the second reduction rate r2 and compare the present phase current output Ip to the second value Ip2 until the present phase current output Ip is equal to the second value Ip2. Then, the controller 24 can be configured to reduce the present phase current output Ip by the third reduction rate r3 and compare the present phase current output Ip to zero until the present phase current output Ip is equal to zero. That is, steps S208, S216, S224 can be replaced with a check to determine whether the present phase current Ip is equal to the first value Ip1, the second value Ip2, and zero, respectively.

In alternate embodiments, the controller 24 can be configured to determine whether the mechanical braking system has been applied. If not applied, the controller 24 can be configured to decrease the present phase current output Ip at a first set of rates r1, r2, r3. If so, the controller 24 can be configured to decrease the present phase current output Ip at a second set of rates r4, r5, r6 that are greater than the first rates r1, r2, r3, respectively. This can shorten the time period to reach a present phase current output Ip that is equal to zero since the mechanical braking system can maintain the vehicle 10 in a stable state if the vehicle 10 is on the inclined surface S.

In alternate embodiments, the vehicle 10 can include an anti-lock braking system (ABS) and the controller 24 can be configured to cause the ABS to apply a braking force to at least the rear wheels 14 or at least the front wheels 12 when the controller 24 executes the phase current reduction algorithm. Thus, the controller 24 can automatically cause the mechanical braking system of the vehicle 10 to prevent or significantly slow the speed of the vehicle 10 downhill if the vehicle 10 is on the inclined surface.

What is claimed is:

1. An output phase current reduction system for an electric vehicle, the electric vehicle including a battery pack, a plurality of wheels, and an electric motor that is configured to drive at least one of the wheels with electric power from the battery pack, the output phase current reduction system comprising:
a controller configured to:
be in electrical communication with the electric motor and the battery pack during operation of the vehicle in a first driving direction; and
operate the electric motor in a phase current reduction mode by gradually reducing a phase current output to the electric motor from a present value to zero such that an acceleration of the electric vehicle in a direction opposed to the first driving direction is less than a predetermined threshold.

2. The output phase current reduction system according to claim 1, wherein the controller is configured to terminate the phase current reduction mode if:
speed data indicative of a rotational speed of the electric motor has a value of zero; and
position data indicative of a position of the accelerator pedal has a value of zero.

3. The output phase current reduction system according to claim 1, wherein the controller is configured to notify an operator of the electric vehicle that the electric motor is operating in the phase current reduction mode.

4. The output phase current reduction system according to claim 1, wherein the controller is configured to reduce the phase current from the present value to an initial value over an initial time interval if the controller initiates the phase current reduction mode, the initial value is less than the present value and greater than zero.

5. The output phase current reduction system according to claim 4, wherein the controller is configured to reduce the phase current from the initial value to an intermediate value over an intermediate time interval if the initial time interval has lapsed, the predetermined intermediate value is less than the initial value and greater than zero.

6. The output phase current reduction system according to claim 4, wherein the controller is configured to reduce the phase current from the present value to the initial value at a linear rate.

7. The output phase current reduction system according to claim 5, wherein the controller is configured to reduce the phase current from the initial value to the intermediate value at a linear rate.

8. The output phase current reduction system according to claim 5, wherein the initial time interval is less than the intermediate time interval.

9. The output phase current reduction system according to claim 5, wherein the controller is configured to reduce the phase current from the intermediate value to zero over a final time interval if the intermediate time interval has lapsed.

10. The output phase current reduction system according to claim 9, wherein the controller is configured to reduce the phase current from the intermediate value to zero at a linear rate.

11. The output phase current reduction system according to claim 9, wherein the final time interval is less than the intermediate time interval.

12. An output phase current reduction system for an electric vehicle, the electric vehicle including an accelerator pedal, a battery pack, a plurality of wheels, and an electric motor that is configured to drive at least one of the wheels with electric power from the battery pack, the output phase current reduction system comprising:
a position sensor configured to output data that is indicative of a position of the accelerator pedal within a range from a released position to a maximum position; and
a controller configured to:
be in electrical communication with the position sensor, the electric motor, and the battery pack;
operate the electric motor in a normal mode in which the controller causes a normal value of a phase current to be output to the electric motor, the normal value is proportional to the position of the accelerator pedal; and
terminate the normal mode and operate the electric motor in a phase current reduction mode if:
a rotational speed of the electric motor is less than a speed threshold; and
the phase current is greater than a current threshold, wherein
the controller gradually decreases the phase current output to the electric motor from the normal value to a value less than the normal value when the controller operates the electric motor in the phase current reduction mode.

13. The output phase current reduction system according to claim 12, wherein the controller is configured to terminate the phase current reduction mode and operate the electric motor in the normal mode if a rotational speed of the electric motor has a value of zero and the pedal position corresponds to the released position.

14. The output phase current reduction system according to claim 12, further comprising:
a display in electrical communication with the controller, wherein
the controller is configured to cause the display to present a message while the controller is operating the electric motor in the phase current reduction mode, the message indicative of the electric motor operating in the phase current reduction mode.

15. The output phase current reduction system according to claim 12, wherein the controller is configured to terminate the normal mode and operate the electric motor in the phase current reduction mode if, for a predetermined time, both of the rotation speed is less than the speed threshold and the phase current is greater than the current threshold.

16. The output phase current reduction system according to claim 12, wherein when in the phase current reduction mode the controller is configured to maintain the phase current at zero until the pedal position corresponds to the release position.

17. The output phase current reduction system according to claim 12, wherein the controller is configured to reduce the phase current output to the electric motor at:
an initial rate for an initial time;
an intermediate rate for an intermediate time after the initial time has elapsed, the intermediate rate is less than the initial rate; and
a final rate for a final time after the intermediate time has elapsed, the final rate is different from at least one of the initial rate and the intermediate rate.

18. An output phase current reduction system for an electric vehicle, the electric vehicle including an accelerator pedal, a battery pack, a plurality of wheels, and an electric motor that is configured to drive at least one of the wheels with electric power from the battery pack, the output phase current reduction system comprising:
a position sensor configured to output data that is indicative of a position of the accelerator pedal within a range from a released position to a maximum position; and
a controller configured to:
be in electrical communication with the position sensor, the electric motor, and the battery pack;
if one of a forward drive direction and a reverse drive direction is selected, operate the electric motor in one of:
a normal mode in which the controller causes a normal value of a phase current to be output to the electric motor, the normal value is proportional to the position of the accelerator pedal; and
a phase current reduction mode in which the controller gradually decreases the phase current output to the electric motor from the normal value to a value less than the normal value; and
terminate the normal mode and operate the electric motor in the phase current reduction mode if:
a rotational speed of the electric motor is less than a speed threshold; and
the phase current is greater than a current threshold.

19. The output phase current reduction system according to claim 18, wherein the controller is configured to maintain the phase current at zero until the rotational speed has a value of zero, and the pedal position corresponds to the released position, when the controller operates the electric motor in the phase current reduction mode.

20. The output phase current reduction system according to claim 19, wherein the controller is configured to decrease the phase current at a rate such that the electric motor opposes at least a portion of a downhill acceleration of the electric vehicle.
